(19) United States
(12) Patent Application Publication
(10) Pub. No.: US 2015/0239597 A1
(43) Pub. Date: Aug. 27, 2015

(54) TUBULAR BAG FORMING MACHINE WITH LABELING DEVICE

(71) Applicant: Multivac Marking & Inspection GmbH & Co. KG, Enger (DE)

(72) Inventors: Georg Austermeier, Hoevelhof (DE); Udo Henrichs, Bielefeld (DE); Udo Kästing, Detmold (DE)

(21) Appl. No.: 14/624,267

(22) Filed: Feb. 17, 2015

(30) Foreign Application Priority Data
Feb. 21, 2014 (EP) 14156161.3

(51) Int. Cl. B65C 9/34; B65C 9/18

(52) U.S. Cl. CPC B65C 9/34; B65C 9/1865

(57) ABSTRACT

The present invention relates to a tubular bagging machine with a labeling device and to a method of operating a tubular bagging machine. The labeling device includes a label dispenser that dispenses a label onto an intermediate belt. The intermediate belt then conveys the label to a transfer belt that attaches and carries away the label in a transverse direction to a labeling position. Once at the labeling position the label is applied to a film web traveling in a direction transverse to the movement of the transfer belt.

### CROSS-REFERENCE TO RELATED APPLICATIONS

This application claims priority to European Patent Application Number 14156161.3 filed Feb. 21, 2014, to Georg Austermeier et al., currently pending, the entire disclosure of which is incorporated herein by reference.

### FIELD OF THE INVENTION

The present invention relates to a bag forming, filling and sealing packaging machine with a labeling device. The present invention also relates to a method of labeling bags in a bag forming, filling and sealing packaging machine.

### BACKGROUND OF THE INVENTION

WO 2009/010205 A1 discloses a labeling device for thermoform packaging machines for multi-lane and multi-row application of labels on packages, which are guided in a film web before they are singularized. The labeling device comprises a label dispenser oriented transversely to the conveying direction of the film web and is provided with a first label conveying belt which is also oriented transversely to the conveying direction. The labeling device comprises a second label conveying belt, which applies the labels to the film web, the second label conveying belt being oriented in the conveying direction of the film web.

In addition, vertical tubular bagging machines are known, which comprise an integrated labeling device in the interior of the machine for applying labels to a film web prior to forming the film web into a tube, filling it with products and sealing it. Packaging machines of the tubular bag forming, filling and sealing type, called tubular bagging machines for short, are packaging machines in which a web-shaped packaging film is formed into a tube prior to filling individual sections of this tube as separate packages with a product. Vertical tubular bagging machines are characterized in that the individual tubular bags are filled with the product in the vertical direction from above. Such vertical tubular bagging machines are described e.g., in DE 196 31 258 A1, DE 195 16 870 B4, DE 44 47 051 C2 or DE 196 28 098 A1. With regards to the general configuration of a tubular bagging machine, and in particular, the general configuration of a vertical tubular bagging machine, reference is explicitly made to these four documents. A disadvantage of known tubular bagging machines is the poor accessibility of the labeling device, e.g., for the purpose of changing a label roll. In order to do so, it is normally necessary to open protection doors, and this leads to a standstill of the whole tubular bagging machine.

### SUMMARY OF THE INVENTION

It is the object of the present invention to provide a bag forming machine with a labeling device having improved accessibility and ergonomics of the labeling device, preferably in the case of a vertical tubular bagging machine.

The tubular bagging machine according to one embodiment of the present invention includes a labeling device for applying labels to a film web, where the labeling device may include a label dispenser and a transfer belt. The tubular bagging machine may also include an intermediate belt provided between the label dispenser and the transfer belt, where the intermediate belt may be oriented along (or parallel to) a label dispensing direction of the label dispenser, and the transfer belt may be oriented orthogonally to the intermediate belt. This may allow the label dispenser to be arranged in the external area of the tubular bagging machine so that an improved accessibility, such as for exchanging a label roll, is given.

According to a particularly advantageous embodiment, the tubular bagging machine is a vertical tubular bagging machine. Vertical tubular bagging machines allow the label dispenser to be attached to an outer side of the machine frame. The label dispenser can here be arranged selectively on a right or on a left side of the film web, which increases the flexibility of the machine.

In accordance with one embodiment of the present invention, a respective label dispenser is provided on the right side and on the left side of the film web. A common transfer belt may be provided between the two label dispensers so that a redundant system exists. Redundant means here that the tubular bagging machine can continue to produce while the empty label reel is being replaced on a label dispenser that stands still, since, by means of the other label dispenser, new labels can still be fed continuously to the transfer belt and applied to the film web. The transfer belt may be arranged orthogonally to a film conveying direction of the packaging machine.

The intermediate belt may have, in the label dispensing direction, a width that is smaller than the width of the label to be conveyed. This allows the area on the intermediate belt conveying the label, with its adhesive surface placed on the intermediate belt, to be smaller than the total area of the label. This additionally allows, at least one free end of the label, which projects laterally beyond the intermediate belt, to be pressed onto the transfer belt so as to be further conveyed by the transfer belt. A low adhesive force of the label on the intermediate belt may be provided to allow the label to be detached more easily from the intermediate belt and to be then transferred to the transfer belt.

The transfer belt may have, in the film conveying direction, a width that is smaller than the width of the label to be conveyed, so that a free end of the label, which projects beyond the transfer belt, can be pressed onto the film web. The label can thus be stripped from the transfer belt by the film web when the film is being advanced and can be applied fully to the film web.

The intermediate belt and the transfer belt may be configured for receiving thereon the labels with their adhesive surface, which may be on the lower surface of the label, and for conveying the labels. The labels can thus be conveyed reliably even in the case of fast conveying movements.

According to one embodiment, the label dispenser may be arranged outside a machine frame of the tubular bagging machine so as to improve the accessibility.

The label dispensing direction may correspond to the film conveying direction so as to avoid excessively large dimensions of the tubular bagging machine.

A method according to one embodiment of the present invention for operating a tubular bagging machine including a labeling device, which may comprise a label dispenser, an intermediate belt and a transfer belt, provides the steps of:

dispensing a label from the label dispenser in a label dispensing direction onto the intermediate belt,

conveying the label by means of the intermediate belt to a transfer position,

transferring the label from the intermediate belt to the transfer belt by means of the transfer belt at the transfer position,

conveying the label by means of the transfer belt, in a direction transverse to a film conveying direction, to a labeling position, and

applying the label to a film web at the labeling position.

Such a method may allow for applying labels to a film web located outside the machine frame, or not inside the machine frame of the tubular bagging machine, and may allow executing an exchange of labels without the necessity of stopping the tubular bagging machine, e.g., by opening protection doors.

The label may be conveyed on the intermediate belt and the transfer belt such that the label has respective free ends projecting beyond the intermediate belt and the transfer belt, so that the label can be transferred more effectively from the intermediate belt to the transfer belt and from there to the film web.

During such transfer, the free end of the label may be pressed onto the film web and may be stripped from the transfer belt through the advance movement of the film web in the film conveying direction.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a front perspective view of a tubular bagging machine with a labeling device according to one embodiment of the present invention;

FIG. 2 is a rear perspective view of the tubular bagging machine of FIG. 1 illustrating the belt routing of a label belt; and

FIG. 3 is an enlarged rear perspective view of the labeling device of FIG. 1.

Like components are provided with like reference numerals throughout the figures.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

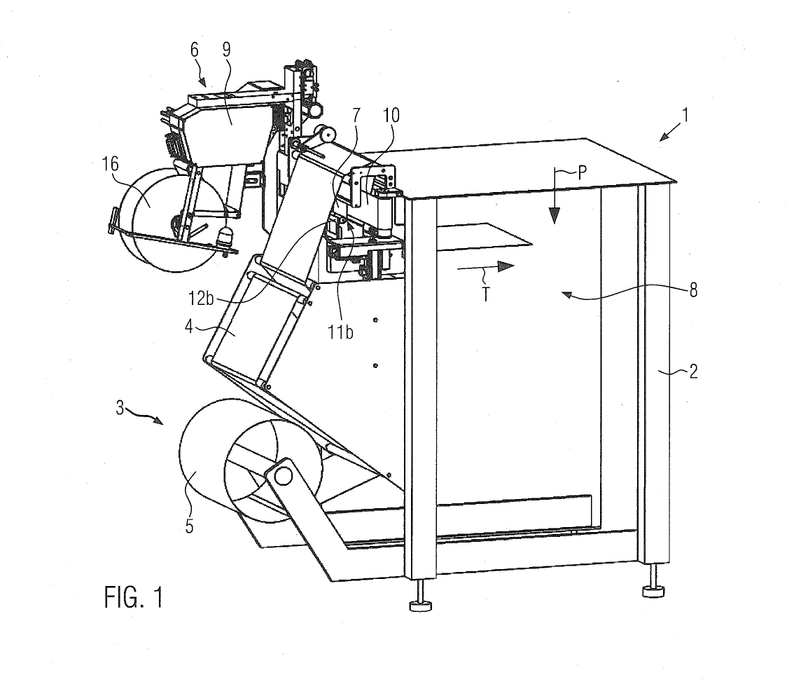

FIG. 1 shows in a schematic representation a tubular bagging machine 1, which may be a bag forming, filling and sealing machine. According to one embodiment of the present invention the tubular bagging machine 1 is in the form of a vertical tubular bagging machine 1. The tubular bagging machine 1 may comprise a machine frame 2 having an unwinding unit 3 for a film web 4 that may be arranged on the left side thereof. The film web 4 may be unwound from a film roll 5 and fed upwards to a labeling device 6, from where it may be conducted into the interior 8 of the tubular bagging machine 1 after application of a label 7. There, the film web 4 may be formed into a tube in the manner known and products, which are not shown in detail, may be fed from above according to the direction of the arrow P and packed.

The labeling device 6 may comprise a label dispenser 9 that can be provided outside the tubular bagging machine 1 on the machine frame 2. The labeling device 6 may include a transfer belt 10 that can move in a generally horizontal direction of movement so that a free end 11b of the label 7 can be pressed onto the film web 4 by means of a contact pressure roll 12b at a labeling position. The contact pressure roll 12b may apply pressure to the upper surface of the label 7, thus pressing the lower surface thereof onto the film web 4, where the lower surface can be the adhesive side of the label 7. Part of the label 7 may adhere to the film web 4 and the advance movement of the film web 4 in a film conveying direction T at the labeling position may ensure that the label 7 will be fully removed from the transfer belt 10, which may be stationary, and pressed across the entire surface thereof onto the film web 4 by means of the contact pressure roll 12b. The label 7 to be applied may be conveyed to its labeling position by means of the transfer belt 10.

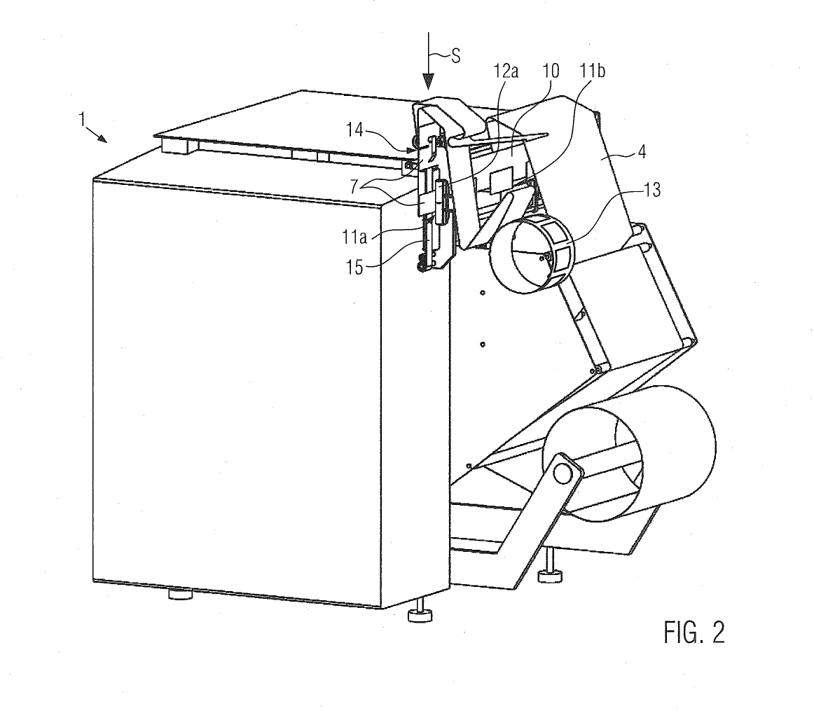

FIG. 2 shows the routing of a label belt 13. The conveying direction of the label belt 13 may be parallel to the direction of movement of the film web 4. The label belt 13 may have provided thereon a plurality of labels 7, which can be conveyed to a dispensing edge 14 of the label dispenser 9. Upon reaching the dispensing edge 14, the plurality of labels 7 may be dispensed in a dispensing direction S from the label belt 13 onto an intermediate belt 15 such that the lower or adhesive surface of the labels 7 faces the intermediate belt 15. The intermediate belt 15 can be oriented in the dispensing direction S. The label 7 can be dispensed onto the intermediate belt 15 and taken over by the intermediate belt 15 such that the adhesive surface of the label 7 can contact the intermediate belt 15 only partly, preferably in a central area thereof, so that a free end 11a of the label 7 can laterally protrude beyond the intermediate belt 15 in the direction of the transfer belt 10. The intermediate belt 15 may convey the label 7 to a transfer position, at which the free end 11a of the label 7 can be pressed onto the transfer belt 10 by means of a contact pressure roll 12a. The transfer belt 10 may then, during an advance movement in the direction of the labeling position, strip the label 7 from the intermediate belt 15 and take it over, enabling the label 7 to travel with the transfer belt 10. The label 7 may be taken over such that the label 7 also has a free end 11b on the side of the transfer belt 10 at which the label 7 is applied to the film web 4 with the free end 11b thereof.

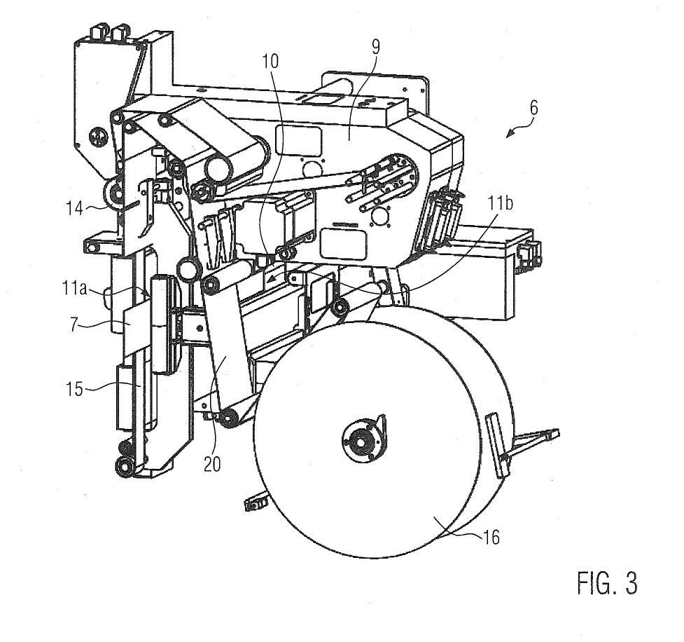

FIG. 3 shows an enlarged detail view of the labeling device 6. The label dispenser 9 can comprise a label roll 16 which has to be changed during a changeover to a different type of labels or when the label belt 20 has been consumed. As can easily be seen in FIG. 3, the label roll 16 is easily accessible, even if the label dispenser 9 were located on the opposite side of the film web 4 or if an additional second label dispenser 9 with an intermediate belt 15 were provided there.

What is claimed is:

1. A tubular bagging machine comprising:
a labeling device for applying labels to a film web, the labeling device comprising:
a first label dispenser;
a transfer belt; and
an intermediate belt provided between the label dispenser and the transfer belt;
wherein the intermediate belt is oriented along a label dispensing direction of the label dispenser, and wherein the transfer belt is oriented generally orthogonal to the intermediate belt.

2. The tubular bagging machine according to claim 1, wherein the tubular bagging machine is a vertical tubular bagging machine.

3. The tubular bagging machine according to claim 1 further comprising a second label dispenser, wherein the first and second label dispensers are provided on a right side and on a left side of the film web, respectively.

4. The tubular bagging machine according to claim 3, wherein the transfer belt moves between and serves both the first and second label dispensers.

5. The tubular bagging machine according to claim 1, wherein, at a labeling position, the transfer belt is operable to move generally orthogonal to a film conveying direction of the tubular bagging machine.

6. The tubular bagging machine according to claim 1, wherein the intermediate belt has a width less than a width of the label in the label dispensing direction.

7. The tubular bagging machine according to claim 1, wherein the transfer belt has a width less than a width of the label in the film conveying direction.

8. The tubular bagging machine according to claim 1, wherein the intermediate belt and the transfer belt are configured for receiving the labels, and wherein the labels have an adhesive surface for at least partially attaching to the intermediate belt and the transfer belt.

9. The tubular bagging machine according to claim 1 further comprising a machine frame, wherein the label dispenser is attached to an outer side of the machine frame.

10. The tubular bagging machine according to claim 1, wherein the label dispensing direction corresponds to the film conveying direction.

11. A method of operating a tubular bagging machine with a labeling device including a label dispenser, an intermediate belt and a transfer belt, the method comprising the steps of:
dispensing a label from the label dispenser in a label dispensing direction onto the intermediate belt;
conveying the label by means of the intermediate belt to a transfer position;
transferring the label from the intermediate belt to the transfer belt;
conveying the label, in a direction transverse to a film conveying direction, by means of the transfer belt to a labeling position; and
applying the label to a film web at the labeling position.

12. The method according to claim 11, wherein the label is conveyed on the intermediate belt such that the label has at least one free end projecting beyond the intermediate belt, and wherein the label is conveyed on the transfer belt such that the label has at least one free end projecting beyond the transfer belt.

13. The method according to claim 12, wherein during the applying step, the at least one free end of the label that is projecting beyond the transfer belt is pressed onto the film web and the label is stripped from the transfer belt through the advance movement of the film web in the film conveying direction.
